(19) United States
(12) Patent Application Publication
(10) Pub. No.: US 2016/0014621 A1
(43) Pub. Date: Jan. 14, 2016

(54) METHOD AND APPARATUS FOR MANAGING AND PROCESSING POLICY PROFILE RESTRICTIONS

(71) Applicant: InterDigital Patent Holdings, Inc., Wilmington, DE (US)

(72) Inventor: Dimitrios Karampatsis, Ruislip (GB)

(73) Assignee: INTERDIGITAL PATENT HOLDINGS, INC., Wilmington, DE (US)

(21) Appl. No.: 14/863,957

(22) Filed: Sep. 24, 2015

Related U.S. Application Data
(63) Continuation of application No. 13/192,129, filed on Jul. 27, 2011.
(60) Provisional application No. 61/369,285, filed on Jul. 30, 2010.

(51) Int. Cl. H04W 24/02; H04L 12/24

(52) U.S. Cl. CPC H04W 24/02; H04L 41/0816

(57) ABSTRACT

Techniques for configuring policy restriction are disclosed. A wireless transmit/receive unit (WTRU) may generate a user-defined policy profile, which is information provided by a user of the WTRU for configuration of parameters for a policy and/or charging control. The WTRU may send the user-defined policy profile to a network. The user-defined policy profile may be used along with network operator-provided policy rules by a policy decision function to set up policy rules for policy and/or charging control for the WTRU. The user-defined policy profile may configure a quality of service limit, a data usage limit, a time usage limit, or an access control. The user-defined policy profile may contain a policy profile identity (ID), a policy profile type information element, and a restricted subscriber ID. The WTRU may send the user-defined policy profile in an initial attach request message or subsequent messages or include it in an SIP REGISTER message.

### CROSS REFERENCE TO RELATED APPLICATIONS

This application is a continuation of U.S. patent application Ser. No. 13/192,129 filed Jul. 27, 2011 which claims the benefit of U.S. provisional application No. 61/369,285 filed Jul. 30, 2010, the contents of which are hereby incorporated by reference herein.

### BACKGROUND

Currently, in the third generation partnership project (3GPP), policy is managed from a network via a policy and charging control (PCC) infrastructure. PCC allows for a centralized mechanism of control for delivering quality of service (QoS) and enforcing charging in the network. All QoS handling is controlled by the PCC infrastructure based on operator and/or application requirements. PCC is focused on control of the QoS and charging down to the granularity of a single service data flow (SDF). An SDF consists of a set of packet flows (Internet protocol (IP) packet flows).

FIG. 1 shows a conventional PCC architecture set forth by the 3GPP. An Rx reference point resides between the application function (AF) and the policy and charging rules function (PCRF). The AF may be a third party application server. The Rx reference point enables transport of application level session information from the AF to the PCRF. Such information includes, but is not limited to, IP filter information to identify the service data flow for policy control and/or differentiated charging, media/application bandwidth requirements for QoS control, etc.

The Gx reference point resides between the policy and changing enforcement function (PCEF) and the PCRF. The Gx reference point enables the PCRF to have dynamic control over the PCC behavior at the PCEF. The Gx reference point enables the signaling of the PCC decision, which governs the PCC behavior, and it supports numerous functions including, but not limited to, request for PCC decision from the PCEF to the PCRF, provision of IP flow mobility routing information from the PCEF to the PCRF, provision of PCC decision from the PCRF to the PCEF, delivery of IP-connectivity access network (IP-CAN)-specific parameters from the PCRF to the PCEF or from the PCEF to the PCRF, or the like.

The Gxx reference point resides between the PCRF and the bearer binding and event reporting function (BBERF). The Gxx reference point enables the PCRF to have dynamic control over the BBERF behavior. The Gxx reference point enables the signaling of QoS control decisions and it supports functions including, but not limited to, establishment of Gxx session by the BBERF, termination of Gxx session by the BBERF or the PCRF, establishment of gateway control session by the BBERF, termination of gateway control session by the BBERF or the PCRF, delivery of IP-CAN-specific parameters from the PCRF to the BBERF or from the BBERF to the PCRF, negotiation of IP-CAN bearer establishment mode, or the like.

As shown in FIG. 1, session information is sent from the AF to the PCRF via the Rx interface for the operator/application-driven services, or from the BBERF or PCEF to the PCRF via the Gxx interface or the Gx interface for the wireless transmit/receive unit (WTRU)-driven services. Based on the session information, the PCRF determines PCC rules or QoS rules, which carry information for the access plane to enforce a bearer with specific charging and QoS parameters, thus enforcing adequate delivery of the services requested.

Some network operators offer control of child's device via a web portal where restrictions are placed on the services for the child's device, such as the amount of data downloaded, the number of short messaging service (SMS) texts sent, the amount of purchases allowed in dollars, or restricted outgoing phone numbers, etc. This method of enforcing control is proprietary, i.e., not standardized in 3GPP or any other telecommunications standards.

### SUMMARY

Method and apparatus for configuring policy restriction are disclosed. A wireless transmit/receive unit (WTRU) may generate a user-defined policy profile, which is a set of information provided by a user of the WTRU for configuration of parameters for a policy and/or charging control. The WTRU may send the user-defined policy profile to a network. The user-defined policy profile may be used along with network operator-provided policy rules by a policy decision function to set up policy rules for policy and/or charging control for the WTRU. The user-defined policy profile may configure a quality of service (QoS) limit, a data usage limit, a time usage limit, or an access control. The user-defined policy profile may contain a policy profile identity (ID), a policy profile type information element (IE), and a restricted subscriber ID. The WTRU may send the user-defined policy profile in an initial attach request message or in subsequent messages (e.g., PDN connectivity request) in case the WTRU send the profile over the evolved packet core (EPC)/general packet radio services (GPRS) network, or include the profile in a session initiation protocol (SIP) REGISTER message or subsequesnt message (e.g., INVITE request) over an IMS network.

### BRIEF DESCRIPTION OF THE DRAWINGS

A more detailed understanding may be derived from the following description, given by way of example in conjunction with the accompanying drawings wherein:

FIG. 1 shows a conventional PCC architecture in the 3GPP;

FIG. 2A is a system diagram of an example communications system in which one or more disclosed embodiments may be implemented;

FIG. 2B is a system diagram of an example WTRU that may be used within the communications system illustrated in FIG. 2A;

FIG. 2C is a system diagram of an example radio access network and an example core network that may be used within the communications system illustrated in FIG. 2A;

FIG. 3 shows an example signaling procedure for PCC in one embodiment;

FIG. 4 shows an example signaling procedure for PCC for a different subscriber/WTRU in one embodiment;

FIG. 5 shows an example signaling procedure for PCC implementation in an IP multimedia subsystem (IMS) network;

FIG. 6 shows an example signaling procedure for PCC implementation in an IMS network including a UDR;

FIG. 7 is an example signaling flow for PCC implementation on 3GPP general packet radio service (GPRS) tunneling protocol (GTP) access;

FIG. 8 is an example signaling flow for PCC implementation on 3GPP proxy mobile IP (PMIP) access; and

FIG. 9 is an example signaling flow for PCC implementation on a non-3GPP access.

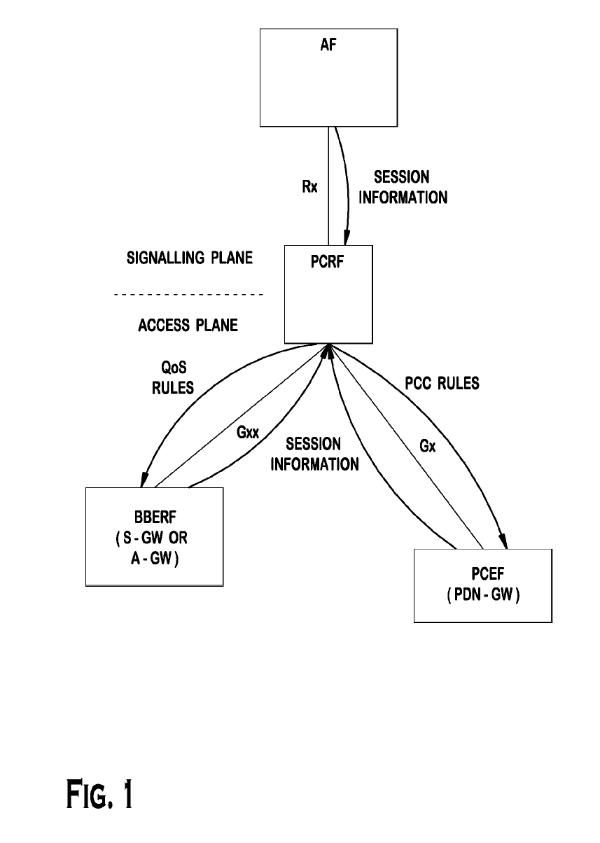

### DETAILED DESCRIPTION

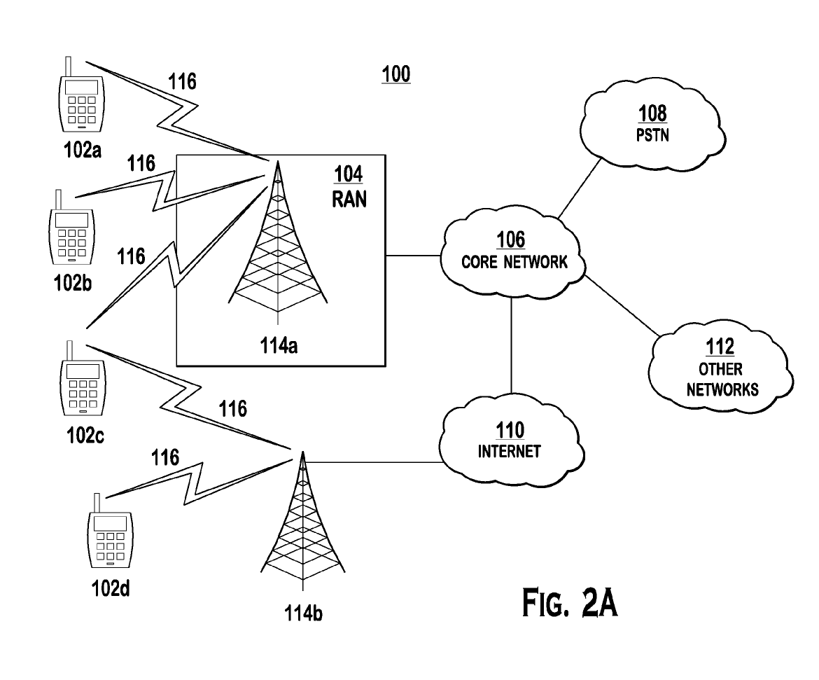

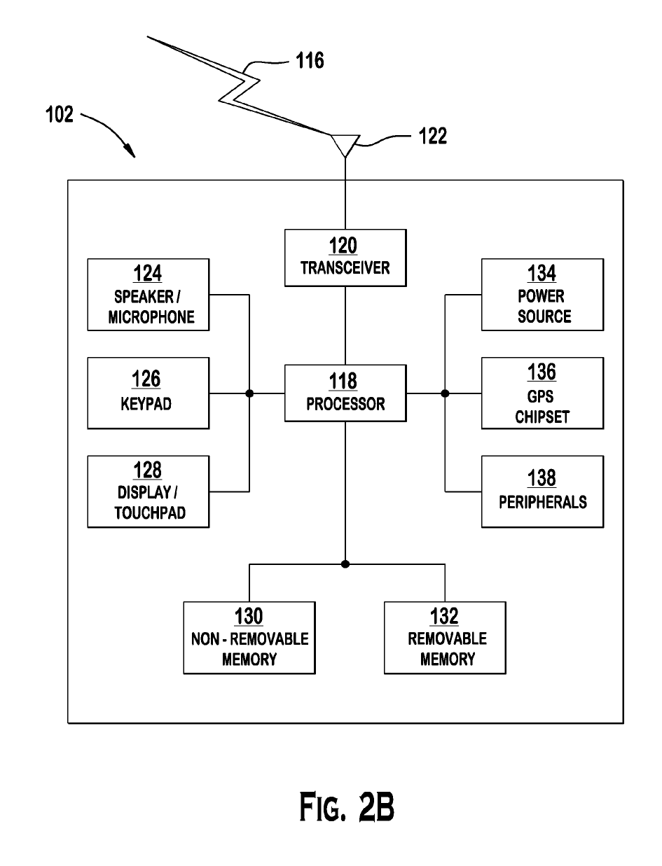

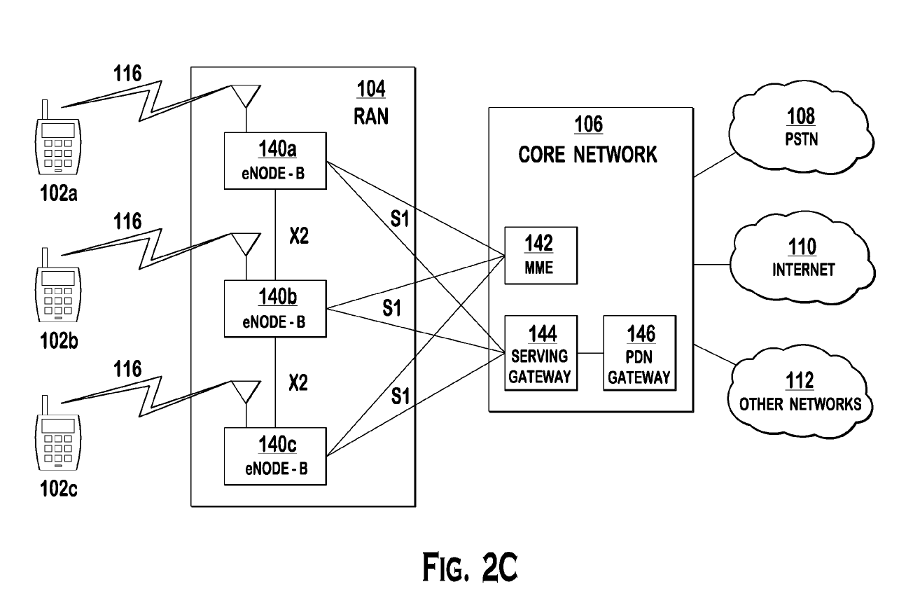

FIG. 2A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications system 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 2A, the communications system 100 may include WTRUs 102A, 102B, 102C, 102D, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102A, 102B, 102C, 102D may be any type of device configured to operate and/or communicate in a wireless environment. By way of example, the WTRUs 102A, 102B, 102C, 102D may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications system 100 may also include a base station 114A and a base station 114B. Each of the base stations 114A, 114B may be any type of device configured to wirelessly interface with at least one of the WTRUs 102A, 102B, 102C, 102D to facilitate access to one or more communication networks, such as the core network 106, the Internet 110, and/or the networks 112. By way of example, the base stations 114A, 114B may be a base transceiver station (BTS), a Node-B, an eNodeB, a Home Node-B, a Home eNodeB, a site controller, an access point (AP), a wireless router, and the like. While the base stations 114A, 114B are each depicted as a single element, it will be appreciated that the base stations 114A, 114B may include any number of interconnected base stations and/or network elements.

The base station 114A may be part of the RAN 104, which may also include other base stations and/or network elements (not shown), such as a base station controller (BSC), a radio network controller (RNC), relay nodes, etc. The base station 114A and/or the base station 114B may be configured to transmit and/or receive wireless signals within a particular geographic region, which may be referred to as a cell (not shown). The cell may further be divided into cell sectors. For example, the cell associated with the base station 114A may be divided into three sectors. Thus, in one embodiment, the base station 114A may include three transceivers, i.e., one for each sector of the cell. In another embodiment, the base station 114A may employ multiple-input multiple output (MIMO) technology and, therefore, may utilize multiple transceivers for each sector of the cell.

The base stations 114A, 114B may communicate with one or more of the WTRUs 102A, 102B, 102C, 102D over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114A in the RAN 104 and the WTRUs 102A, 102B, 102C may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed DL Packet Access (HSDPA) and/or High-Speed Uplink Packet Access (HSUPA).

In another embodiment, the base station 114A and the WTRUs 102A, 102B, 102C may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114A and the WTRUs 102A, 102B, 102C may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114B in FIG. 2A may be a wireless router, Home Node-B, Home eNodeB, or access point, for example, and may utilize any suitable RAT for facilitating wireless connectivity in a localized area, such as a place of business, a home, a vehicle, a campus, and the like. In one embodiment, the base station 114B and the WTRUs 102C, 102D may implement a radio technology such as IEEE 802.11 to establish a wireless local area network (WLAN). In another embodiment, the base station 114B and the WTRUs 102C, 102D may implement a radio technology such as IEEE 802.15 to establish a wireless personal area network (WPAN). In yet another embodiment, the base station 114B and the WTRUs 102C, 102D may utilize a cellular-based RAT (e.g., WCDMA, CDMA2000, GSM, LTE, LTE-A, etc.) to establish a picocell or femtocell. As shown in FIG. 2A, the base station 114B may have a direct connection to the Internet 110. Thus, the base station 114B may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102A, 102B, 102C, 102D. For example, the core network 106 may provide call control, billing services, mobile location-based services, pre-paid calling, Internet connectivity, video distribution, etc., and/or perform high-level security functions, such as user authentication. Although not shown in FIG. 2A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102A, 102B, 102C, 102D to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102A, 102B, 102C, 102D in the communications system 100 may include multi-mode capabilities, i.e., the WTRUs 102A, 102B, 102C, 102D may include multiple transceivers for communicating with different wireless networks over different wireless links. For example, the WTRU 102C shown in FIG. 2A may be configured to communicate with the base station 114A, which may employ a cellular-based radio technology, and with the base station 114B, which may employ an IEEE 802 radio technology.

FIG. 2B is a system diagram of an example WTRU 102. As shown in FIG. 2B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 2B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114A) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 2B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114A, 114B) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 2C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNodeBs 140A, 140B, 140C, though it will be appreciated that the RAN 104 may include any number of eNodeBs while remaining consistent with an embodiment. The eNodeBs 140A, 140B, 140C may each include one or more transceivers for communicating with the WTRUs 102A, 102B, 102C over the air interface 116. In one embodiment, the eNodeBs 140A, 140B, 140C may implement MIMO technology. Thus, the eNodeB 140A, for example, may use multiple antennas to transmit wireless signals to, and receive wireless signals from, the WTRU 102a.

Each of the eNodeBs 140A, 140B, 140C may be associated with a particular cell (not shown) and may be configured to handle radio resource management decisions, handover decisions, scheduling of users in the uplink and/or DL, and the like. As shown in FIG. 2C, the eNodeBs 140A, 140B, 140C may communicate with one another over an X2 interface.

The core network 106 shown in FIG. 2C may include a mobility management gateway (MME) 142, a serving gateway (SGW) 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNodeBs 140A, 140B, 140C in the RAN 104 via an S1 interface and may serve as a control node. For example, the MME 142 may be responsible for authenticating users of the WTRUs 102A, 102B, 102C, bearer activation/deactivation, selecting a particular SGW during an initial attach of the WTRUs 102A, 102B, 102C, and the like. The MME 142 may also provide a control plane function for switching between the RAN 104 and other RANs (not shown) that employ other radio technologies, such as GSM or WCDMA.

The SGW 144 may be connected to each of the eNodeBs 140A, 140B, 140C in the RAN 104 via the S1 interface. The SGW 144 may generally route and forward user data packets to/from the WTRUs 102A, 102B, 102C. The SGW 144 may also perform other functions, such as anchoring user planes during inter-eNodeB handovers, triggering paging when DL data is available for the WTRUs 102A, 102B, 102C, managing and storing contexts of the WTRUs 102A, 102B, 102C, and the like.

The SGW 144 may also be connected to the PDN gateway 146, which may provide the WTRUs 102A, 102B, 102C with access to packet-switched networks, such as the Internet 110, to facilitate communications between the WTRUs 102A, 102B, 102C and IP-enabled devices.

The core network 106 may facilitate communications with other networks. For example, the core network 106 may provide the WTRUs 102A, 102B, 102C with access to circuit-switched networks, such as the PSTN 108, to facilitate communications between the WTRUs 102A, 102B, 102C and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102A, 102B, 102C with access to the networks 112, which may include other wired or wireless networks that are owned and/or operated by other service providers.

The embodiments disclosed herein are applicable to a network implementing PCC functionality (3GPP or non-3GPP). The embodiments may be applicable to a network implementing the 3GPP IMS. The embodiments may be applicable to a network implementing a 3GPP user data convergence (UDC), wherein a centralized user data repository (UDR) communicates via the Ud interface to application front-ends (FEs) that interface with the IMS core network and the PCC infrastructure. The application FEs convert the information provided via the Ud interface to the protocol corresponding to the core network or PCC infrastructure interfaces.

In accordance with embodiments disclosed herein, a user may dynamically control, (e.g., restrict), the policy for the subscriber or the subscriber's device, (i.e., WTRU), from the user's device. The policy control is a process whereby the policy decision function, (e.g., PCRF), indicates to the policy enforcement function how to control the IP connectivity access network (IP-CAN) bearer. The policy control includes QoS control, gating control, (e.g., blocking or allowing packets), or the like. For example, a user may restrict the amount of traffic usage per day or any other time period, (e.g., download limited to 100 Mbytes/day), an access to high QoS content or certain websites, the number of text messages, the amount of purchases through online, outgoing phone numbers, etc. Such restrictions may be defined dynamically since the user may choose to remove or update the restrictions placed on the subscriber or the subscriber's device, (i.e., WTRUs), as needed.

A user may place a restriction(s) on policy on the subscription or device, (i.e., user-defined policy profile), directly from the user's WTRU, (i.e., user's device). The user-defined policy profile is a set of information provided by the user for configuration and restrictions for PCC parameters for the policy control and/or charging control. The restrictions may be sent via a 3GPP or any other type of network, (e.g., IP multi-media subsystem (IMS), GSM EDGE radio access network (GERAN), universal terrestrial radio access network (UTRAN), long term evolution (LTE) access, or the like), to the PCC infrastructure, which provides a control on the restrictions that can be defined by the user, (e.g., restrictions on QoS).

The user-defined policy profile may be defined to allow dynamic configuration of various PCC parameters, such as a QoS limit, (e.g., whether the device may have an access to best effort or guaranteed bit rate bearers), a data usage limit, (e.g., the maximum amount of data the device may download), a time usage limit, (e.g., an access to the network is limited for certain amount of time or at certain time of the day), and banned websites, ports, or IP addresses, (e.g., firewall), or the like.

The user-defined policy profile may be dynamically configured by the user. Different policy profiles may be defined for each device or subscription. A user may apply restrictions on devices that are on a different subscription or device(s). The user may define policy profiles to another person's device or subscription, (e.g., a parent may place restrictions on a child's device that is part of a different subscription). Multiple policy profiles that represent multiple restrictions, (e.g., download limit and data rate limit), may be defined for a device or subscription.

Two types of policy profiles may be defined: a dynamic policy profile and a static policy profile. A dynamic policy profile may be configured and sent by the user via a WTRU. Static policy profiles are pre-defined by the network operator or the user and stored at the subscription database, (e.g., user data repository (UDR), subscription profile repository (SPR), home subscriber server (HSS), or the like).

The user-defined policy profile may not override the user's subscription package to the network, (i.e., the PCC rule that has been provisioned by the operator). It may be the PCRF, (i.e., a policy enforcement point in the 3GPP networks), that decides on policy. The dynamic policy profile defined by the user is an additional parameter that allows the PCRF to adequately decide on policy enforcement.

The policy profile may contain a policy profile identity (ID) that is used to differentiate between different profiles. The policy profile may also include a restricted subscriber ID if a user defines restrictions on different devices or subscriptions. For example, the restricted subscriber ID may be the international mobile subscriber identity (IMSI) of the WTRU to which the restriction will apply. The policy profile may also include a policy profile type information element (IE). For example, the policy profile type may be WTRU guaranteed bit rate (WTRU-GBR), WTRU maximum bit rate (WTRU-MBR), a QoS class indicator (QCI) limit, a download limit, a day limit, a traffic flow template (TFT), or the like. The WTRU-GBR may restrict a total GBR for services accessed by the WTRU requiring a guaranteed bearer. The WTRU-MBR may restrict a total best effort rate for services accessed by the WTRU requiring a best effort bearer. The QCI limit may restrict a QCI to the indicated value. The download limit may restrict the maximum downloadable traffic. The day limit may restrict an access to a network, for example, to a certain time period of the day. The TFT is a packet filter for blocking IP addresses and/or ports.

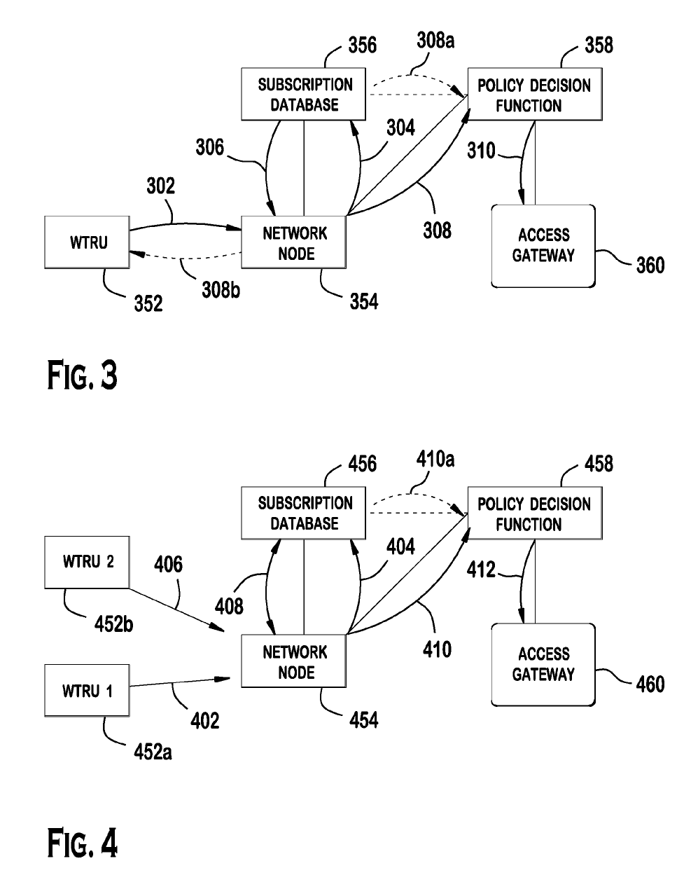

FIG. 3 shows an example signaling procedure for PCC in one embodiment. A WTRU 352 used by a subscriber provides a network node 354, (e.g., MME, SGSN, or proxy call state control function (P-CSCF) in an IMS network node, or the like), with a user-defined policy profile including a user-defined/selected policy restriction(s) (302). The network node 354 detects the user-defined policy profile and sends it to the subscription database 356, (e.g., HSS, SPR, UDR, or the like) (304). The subscription database 356 is responsible for maintaining and authorizing policy profiles. The subscription database 356 checks the user subscription to determine whether the policy profile provided by the WTRU 352 is valid, and checks if other policy profiles (static profiles) have been defined for the subscriber.

The subscription database 356 may then provide the network node 354 with a list of active policy profiles for the subscriber (306). The network node 354 may then send the list of active policy profiles for the subscriber to the policy decision function 358, (e.g., PCRF) (308). Alternatively, if the subscription database 356 has a direct link to the policy decision function, the subscription database 356 may directly send the list of active profiles for the subscriber to the policy decision function 358 (308a). The WTRU 352 may be informed of the active policy profiles (308b).

The policy decision function 358 may locally store the list of policy profiles for the subscriber, for example, for the duration that the WTRU 352 is connected to the network. The policy decision function 358 may decide on policy rules taking into account the received list of the active policy profiles for the subscriber, and send the policy rules (PCC rule) to an access gateway 360, (e.g., S-GW, P-GW, or the like) (310). The PCC rule is a set of information enabling the detection of a service data flow and providing parameters for policy control and/or charging control.

If session information of a newly requested service has parameters that override the restrictions placed on the policy profile for the subscriber, the policy decision function 358 may reject the service request. For example, if the requested QoS for the service is above the WTRU/user restriction, the policy decision function 358 may reject the new session. If the requested QoS is below the WTRU/user restriction, the policy decision function 358 may provide new PCC/QoS rules for the service. If the service requested is of high priority and the QoS requested is above the WTRU restriction, the policy decision function 358 may grant the service based on operator requirements. If the requested service indicates emergency, the policy decision function 358 may ignore the policy restrictions and proceed with setting up bearers for the emergency session.

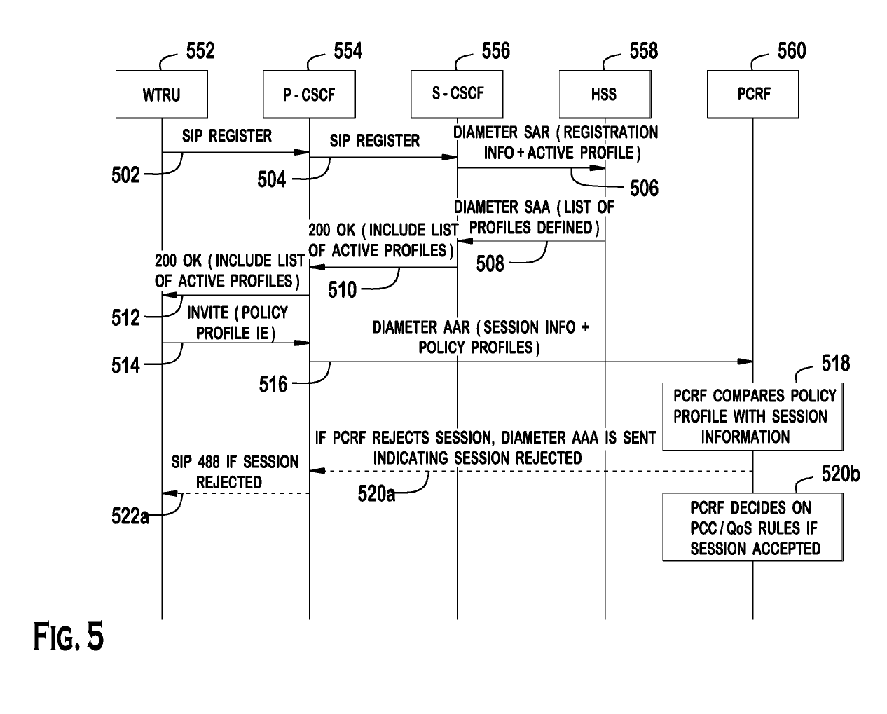

FIG. 4 shows an example signaling procedure for PCC for a different subscriber/WTRU in one embodiment. A first WTRU 452a used by a first subscriber provides a policy profile including a list of user defined/selected policy profile restrictions for a second subscriber (or a second WTRU) to a network node 454, (e.g., MME, SGSN, or P-CSCF in an IMS network node, or the like) (402). The network node 454 detects the policy profile and sends it to the subscription database 456, (e.g., HSS, SPR, UDR, or the like) (404). The subscription database 456 is responsible for maintaining and authorizing policy profiles. The subscription database 456 checks the user subscription if the policy profile provided by the first WTRU 452a is valid, and checks if other policy profiles (static profiles) have been defined for the second subscriber. Since the received policy profile is for a different subscription, the subscription database 456 updates the applicable subscription parameters of the second subscriber.

A second WTRU 452b used by a second subscriber accesses the network node 454 for registration (406). The second WTRU 452b is registered with the subscription database 456 and the subscription database 456 may provide a list of active policy profiles for the second subscriber to the network node 454 (408). When a user attaches to the network, the subscription database 456 may automatically forward the policy profile to the network node 454 or alternatively to a policy decision function 458.

The network node 454 may then send the list of active policy profiles for the second subscriber to the policy decision function 458, (e.g., PCRF) (410). Alternatively, if the subscription database 456 has a direct link to the policy decision function 458, the subscription database 456 may directly send the list of active profiles for the second subscriber to the policy decision function 458 (410a). The policy decision function 458 may locally store the list of active policy profiles for the second subscriber, for example, for the duration that the second WTRU 452b is connected to the network. The policy decision function 458 may decide on policy rules taking into account the received list of the active policy profiles for the second subscriber, and sends the policy rules to an access gateway 460, (e.g., S-GW, P-GW, or the like) (412).

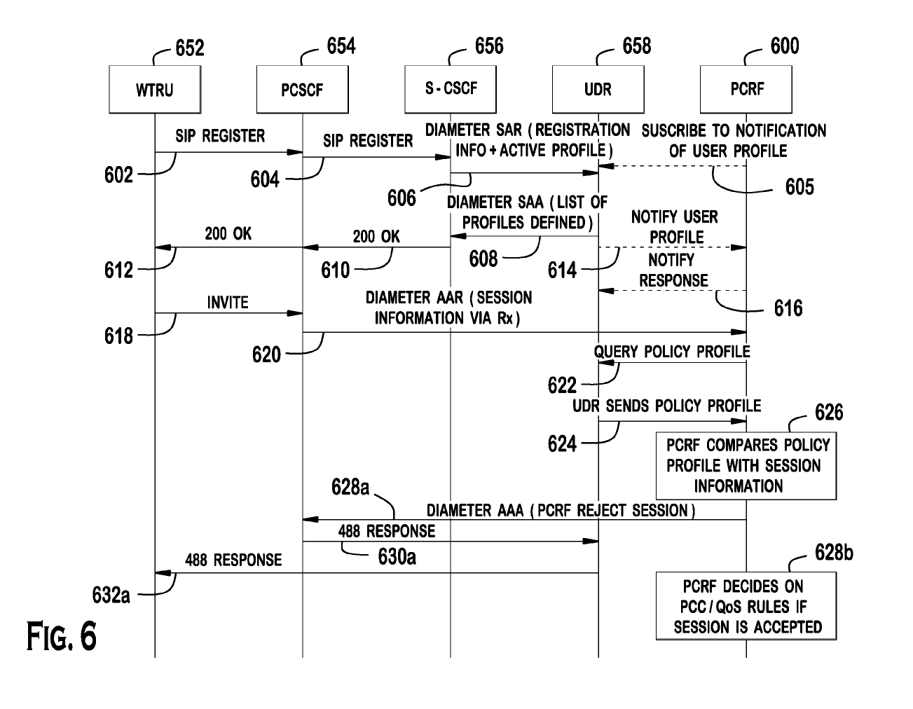

Embodiments for PCC implementation in IMS networks are disclosed hereafter. FIG. 5 shows an example signaling procedure for PCC implementation in an IP multimedia subsystem (IMS) network. A WTRU 552 used by a subscriber sends a session initiation protocol (SIP) register message with a policy profile to a proxy call session control function (P-CSCF) 554 (502), which forwards the SIP register message and the policy profile to a serving call session control function (S-CSCF) 556 (504). The policy profile may be included in an extensible markup language (XML) body. Alternatively, a new P-header, a new feature tag, or a diameter encapsulated message containing PCC rules may be used.

The S-CSCF 556 sends the registration request including the policy profile for the subscriber to the HSS 558, (i.e., subscription database) (506). An additional Diameter attribute-value pair (AVP) may be defined on the Diameter protocol of the Cx interface to convey the policy profile. If the network implements the UDC, the S-CSCF 556 may forward the policy profile via Ud interface to the UDR.

The HSS 558 provides a list of active policy profiles for the subscriber to the S-CSCF 556 (508). The S-CSCF 556 sends a 200 OK message to the WTRU 552 via the P-CSCF 554 (510, 512). The 200 OK message may contain a list of active profiles for the subscriber. The user may amend the policy profile by refreshing the registration information. The device/user may not change the policy profile in normal SIP messages, (e.g., an invite message). If the P-CSCF 554 has an active Rx session with the PCRF 560, the P-CSCF 554 may forward the policy profiles to the PCRF 560.

The WTRU 552 sends an invite message to the P-CSCF 554 to request a service via an IMS network including the policy profiles in the invite message (514). The P-CSCF 554 detects that the policy profile is included in the invite message and includes the policy profile information in the session information forwarded to the PCRF 560 (516). A new Diameter AVP may be defined in Rx interface to convey the policy profile IE.

The PCRF 560 receives the policy profile and may locally store the policy profile for the duration of the service. The PCRF 560 checks the policy profiles against the session information received in the invite message (518). If the PCRF 560 rejects the session request based on the policy profile, the PCRF 560 may send Diameter AAA message to the P-CSCF 554 indicating that the session is rejection (520a). The P-CSCF 554 then sends an SIP 488 message to the WTRU 552 (522a). If the session is accepted, the PCRF 560 decides PCC rules and sends them to a PCEF (520b).

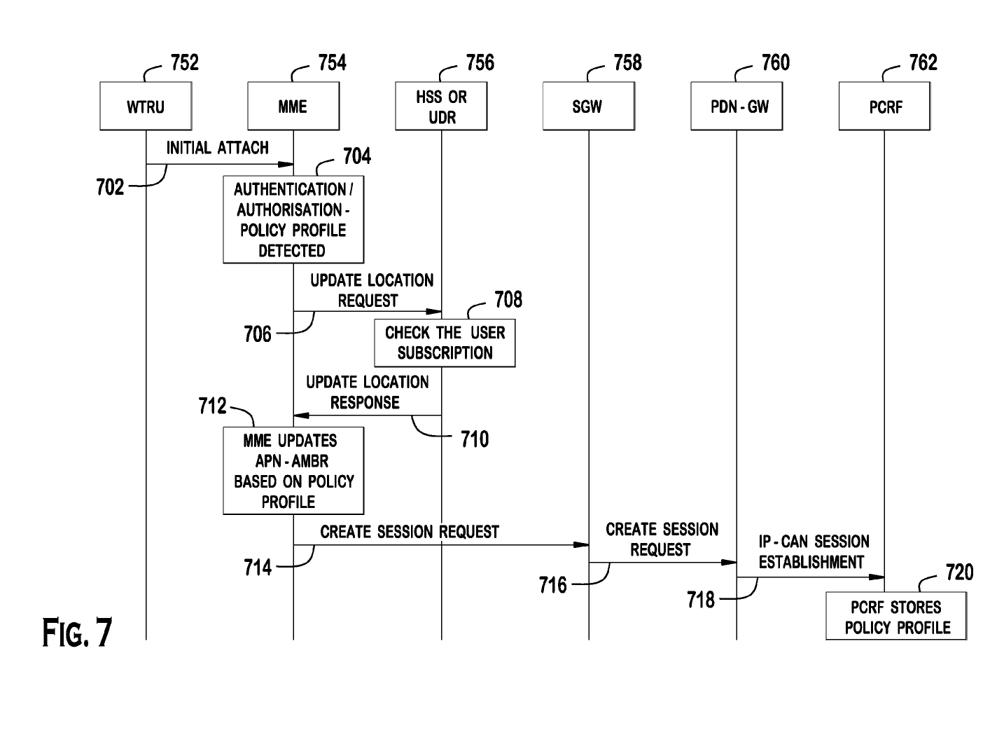

FIG. 6 shows an example signaling procedure for PCC implementation in an IMS network including a UDR. A WTRU 652 used by a subscriber sends an SIP register message with a policy profile to an S-CSCF 656 via a P-CSCF 654 (602, 604). The S-CSCF 656 sends the registration information and the policy profile for the subscriber to the UDR 658 (606). The UDR 658 provides a list of active policy profiles for the subscriber to the S-CSCF 656 (608). The S-CSCF 656 sends a 200 OK message to the WTRU 652 via the P-CSCF 654 (610, 612). The 200 OK message may contain a list of active profiles for the subscriber.

The UDR 658 may provide a policy profile to the PCRF 660. In one embodiment, the PCRF 660 may subscribe to notification of a policy profile (605). The UDR 658 may forward a selected policy profile to the PCRF 660 (614). A new Diameter AVP may be defined to define policy profile (may be the same AVP defined on the Cx interface). The PCRF 660 then sends a response to the UDR 658 (616). The PCRF 660 may locally store the selected profile for the device/subscription. Alternatively, the PCRF 660 may query the UDR 658 as to whether a policy profile exists for the user/WTRU when session information is received, which will be described below.

The WTRU 652 sends an invite message to the P-CSCF 654 to request a service via an IMS network including the policy profiles in the invite message (618). The P-CSCF 654 detects that the policy profile is included in the invite message and includes the policy profile information in the session information forwarded to the PCRF 660 (620). A new Diameter AVP may be defined in Rx interface to convey the policy profile IE.

As stated above, the PCRF 660 may subscribe to notification of a policy profile with the UDR 658, or the PCRF 660 may query the UDR 658 as to whether a policy profile exists for the user/WTRU. If the PCRF 660 does not have the policy profile for the subscriber, the PCRF 660 may query the UDR 658 for the policy profile for the subscriber (622). If a policy profile exists, the UDR 658 provides the PCRF 660 with the policy profile for the subscriber (624). The PCRF 660 may act as an FE to the UDR 658.

The PCRF 660 checks the policy profiles against the session information received in the invite message (626). If the PCRF 660 rejects the session request based on the policy profile, the PCRF 660 may send Diameter AAA message to the P-CSCF 654 indicating that the session is rejection (628a). The P-CSCF 654 then sends an SIP 488 message to the UDR 658, which sends the SIP 488 message to the WTRU 652 (630a, 632a). If the session is accepted, the PCRF 660 decides PCC rules and sends them to a PCEF (628b).

Embodiments for configuring policy profile in non-IMS networks are disclosed hereafter. Additional information elements over the access signaling may be necessary in order to convey user requirements on policy restrictions. The embodiments are provided for 3GPP evolved packet core (EPC) accesses, but the embodiments are also applicable for 3GPP legacy accesses, where for example, an MME is replaced by an SGSN, a PDN-GW is replaced by a GGSN, and an HSS is replaced by an HLR.

The user subscription database, (e.g., HSS, SPR, UDR, or the like), contains a list of static profiles (operator configured) and dynamic profiles (user defined). The WTRU may send dynamic policy profiles in an initial attach message, or in subsequent messages (e.g., PDN connectivity request) in case the WTRU send the profile over the evolved packet core (EPC)/general packet radio services (GPRS) network, or include the profile in an SIP REGISTER message or subsequent message (e.g., INVITE request) over an IMS network. The subscription database is responsible for managing the policy profiles. In the initial attach message, the WTRU may include a user defined/selected policy profile IE. A new IE may be defined on the GTP protocol that defines the policy profile.

FIG. 7 is an example signaling flow for PCC implementation on 3GPP general packet radio service (GPRS) tunneling protocol (GTP) access. A WTRU 752 sends an attach request message to the MME 754 for initial attachment (702). The WTRU 752 may include the policy profile IE in the attach request message, or in subsequent messages, or in an SIP REGISTER message or subsequent messages. A new IE may be defined for the GTP protocol to include the policy profile. The MME 754 carries out authentication with an HSS/UDR 756 when the initial attach message is received from the WTRU 752 (704). If the authentication is successful and the MME 754 detects that the policy profile IE is included in the attach request message, the MME 754 may send an update location request message including the policy profile IE to the HSS/UDR 756 (706). A new diameter AVP may be defined on the Diameter protocol of the S6a interface to convey the policy profile IE.

The HSS/UDR 756 may check the user subscription to determine whether the policy profile provided by the WTRU 752 is valid, and if other policy profiles (static or dynamic) have been defined for this user/WTRU (708). If the policy profile provided by the WTRU 752 is new, the HSS/UDR 756 may update the user subscribed policy profiles.

The HSS/UDR 756 may send an update location response including an international mobile subscriber identity (IMSI) and subscription data to the MME 754 (710). The subscription data may contain one or more packet data network (PDN) subscription contexts. Each PDN subscription context contains an evolved packet system (EPS) subscribed QoS profile and the subscribed access point name (APN)-aggregate maximum bit rate (AMBR). An EPS subscribed QoS profile contains the bearer level QoS parameter values for the default bearer (QCI and Allocation-Retention Priority (ARP)). The APN-AMBR is a subscription parameter stored per APN in the HSS. The APN-AMBR limits the aggregate bit rate that can be expected to be provided across non-GBR bearers and across PDN connections of the same APN. The MME 754 may update the APN-AMBR based on the received policy profile (712). The MME 754 may send a create session request to an S-GW 758 (714). The MME 754 may calculate the WTRU-AMBR and include a policy profile, an APN-AMBR, and a default QoS IE in the create session request.

Depending on the access type, the S-GW 758 may behave differently, (e.g., QoS parameters may be transported differently depending on the access type used). In one embodiment for 3GPP GTP access, the policy profile may be included within the create session request message to the PDN-GW 760 (716). The PDN-GW 760 may initiate an IP-connectivity access network (IP-CAN) session establishment with the PCRF 762 (718). QoS parameters may be included in the IP-CAN session establishment request message. An additional AVP may be defined for the Diameter protocol on the Gx interface to provide the policy profile. The PCRF 762 receives the policy profile and may locally store it for the duration of the session (720). The PCRF 762 may use the policy profile in a subsequent request in order to provide PCC rules accordingly.

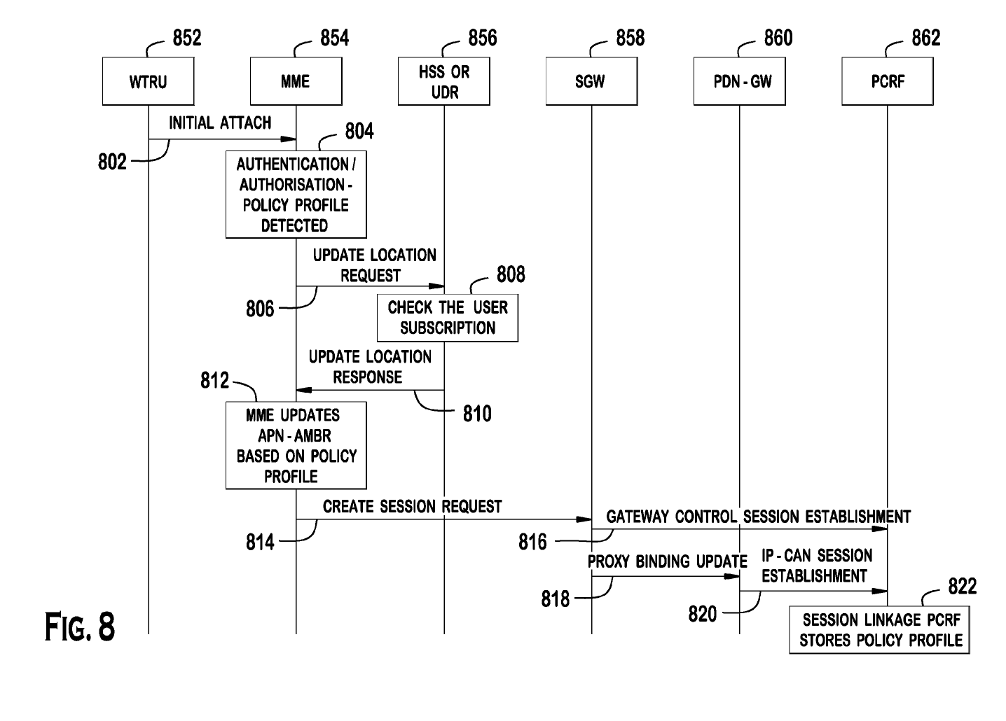

FIG. 8 is an example signaling flow for PCC implementation on 3GPP proxy mobile IP (PMIP) access. A WTRU 852 sends an attach request message to the MME 854 for initial attachment (802). The WTRU 852 may include the policy profile IE in the attach request message, or in subsequent messages (e.g., PDN connectivity request) in case the WTRU send the profile over the EPC/GPRS network, or include the profile in an SIP REGISTER message or subsequent message (e.g., INVITE request) over an IMS network. The MME 854 carries out authentication with an HSS/UDR 856 when the initial attach message is received from the WTRU 852 (804). If the authentication is successful and the MME 854 detects that the policy profile IE is included in the attach request message, the MME 854 may send an update location request message including the policy profile IE to the HSS/UDR 856 (806). A new Diameter AVP may be defined on the diameter protocol of the S6a interface to convey the policy profile IE.

The HSS/UDR 856 may check the user subscription to determine whether the policy profile provided by the WTRU 852 is valid, and if other policy profiles (static or dynamic) have been defined for this user/WTRU (808). If the policy profile provided by the WTRU 852 is new, the HSS/UDR 856 may update the user subscribed policy profiles.

The HSS/UDR 856 may send an update location response including the IMSI and subscription data to the MME 854 (810). The subscription data may contain one or more PDN subscription contexts. Each PDN subscription context contains an EPS subscribed QoS profile and the subscribed APN-AMBR. An EPS subscribed QoS profile contains the bearer level QoS parameter values for the default bearer (QCI and ARP). The APN-AMBR is a subscription parameter stored per APN in the HSS. It limits the aggregate bit rate that can be expected to be provided across non-GBR bearers and across PDN connections of the same APN. The MME 854 may update the APN-AMBR based on the policy profile received (812). The MME 854 may send a create session request to an S-GW 858 (814). The MME 854 calculates the WTRU-AMBR and includes a policy profile, an APN-AMBR, and a default QoS IE in the create session request.

For the 3GPP PMIP access, if the WTRU 852 included a policy profile in the attach request, the S-GW 858 may send the policy profile and other QoS parameters to the PCRF 862 (816). The S-GW 858 may establish a gateway control session with the PCRF 862 via the Gxx interface. A new AVP may be defined in the Diameter protocol of the Gxx interface to include the policy profile. The S-GW 858 may send a proxy binding update to the PDN-GW 860 over an S8 interface (818). The PDN-GW 860 may initiate an IP-CAN session establishment over the Gx interface with the PCRF (820). When the PCRF 862 receives the IP-CAN session establishment request, the PCRF 862 may perform a session linkage between the gateway control session (over the Gxx interface) and an IP-CAN session (over the Gx interface) to confirm the PDN session (822). The PCRF 862 may locally store the policy profile for the duration of the IP-CAN session. The PCRF 862 may use the policy profile in a subsequent request in order to provide QoS rules accordingly.

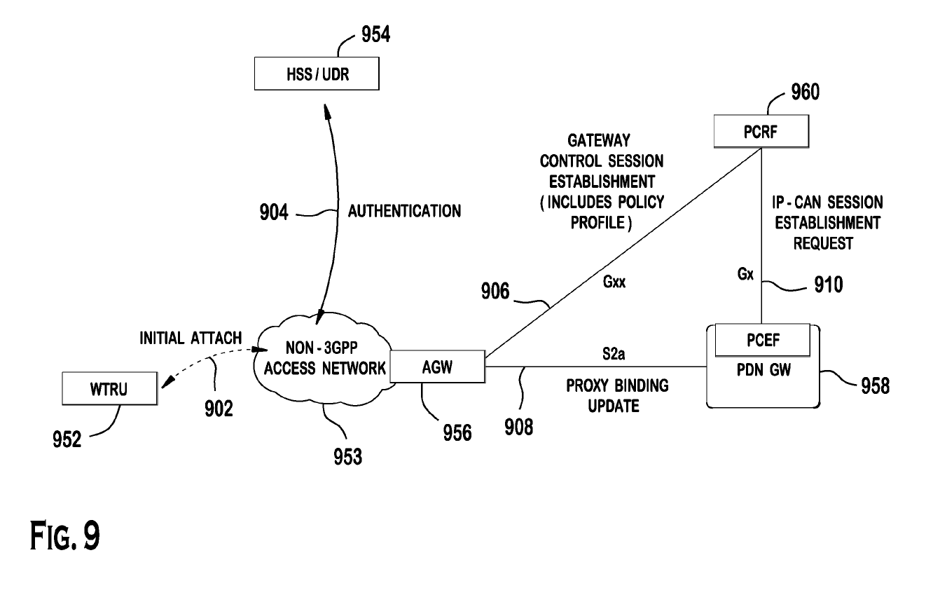

FIG. 9 is an example signaling flow for PCC implementation on a non-3GPP access. A WTRU 952 sends an attach request message to the non-3GPP access network 953 for initial attachment (902). The WTRU 952 may include the policy profile IE in the attach request message or subsequent messages. The non-3GPP access network 953 may carry out authentication with an HSS/UDR 954 when the initial attach message is received from the WTRU 952 and may send the policy profile IE to the HSS/UDR 954 (904). The HSS/UDR 954 may check the user subscription to determine whether the policy profile provided by the WTRU 952 is valid, and if other policy profiles (static or dynamic) have been defined for this user/WTRU. If the policy profile provided by the WTRU 952 is new, the HSS/UDR 954 may update the user subscribed policy profiles. The HSS/UDR 954 may send a response including an IMSI and subscription data to the access network (904).

The A-GW 956 may send a gateway control session request including the policy profile to a PCRF 960 (906). The A-GW 956 may send a proxy binding update to the PDN-GW 958 (908). The PDN-GW 958 may initiate an IP-CAN session establishment with the PCRF 960 (910). The PCRF 960 may locally store the policy profile for the duration of the IP-CAN session. The PCRF 960 may use the policy profile in a subsequent request in order to provide QoS rules accordingly.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
receiving, by a first wireless transmit/receive unit (WTRU), an input from a user of the first WTRU, wherein the input includes an indication to control cellular traffic data usage of a second WTRU on a same subscription as the first WTRU; and
in response to the input, transmitting a signal to a base station to configure control of the cellular traffic data usage of the second WTRU.

2. The method of claim 1, wherein the control of the cellular traffic data usage is configured dynamically.

3. The method of claim 1, wherein the input further includes an indication for configuring at least one of: a quality of service (QoS) limit, a data usage limit, a time usage limit, and an access control.

4. The method of claim 1, wherein the signal includes a policy profile identity (ID).

5. The method of claim 1, wherein the signal further includes a policy profile type information element (IE) defined by one or more of the following: a WTRU guaranteed bit rate (WTRU-GBR), a WTRU maximum bit rate (WTRU-MBR), a download limit, a day limit, and a traffic flow template (TFT).

6. A first wireless transmit/receive unit (WTRU) comprising:
circuitry configured to receive, by the first WTRU, an input from a user of the first WTRU, wherein the input includes an indication to control cellular traffic data usage of a second WTRU on a same subscription as the first WTRU; and
the circuitry is further configured, in response to the input, to transmit a signal to a base station to configure control of the cellular traffic data usage of the second WTRU.

7. The WTRU of claim 6, wherein the control of the cellular traffic data usage is configured dynamically.

8. The WTRU of claim 6, wherein the input further includes an indication for configuring at least one of: a quality of service (QoS) limit, a data usage limit, a time usage limit, and an access control.

9. The WTRU of claim 6, wherein the signal includes a policy profile identity (ID).

10. The WTRU of claim 6, wherein the signal further includes a policy profile type information element (IE) defined by one or more of the following: a WTRU guaranteed bit rate (WTRU-GBR), a WTRU maximum bit rate (WTRU-MBR), a download limit, a day limit, and a traffic flow template (TFT).

11. A base station comprising:
circuitry configured to receive a signal from a first wireless transmit/receive unit (WTRU), wherein the signal includes an indication to control cellular traffic data usage of a second WTRU on a same subscription as the first WTRU; and
the circuitry further configured to control the cellular traffic data usage of the second WTRU in response to the received signal.

12. The base station of claim 11, wherein the control of the cellular traffic data usage is configured dynamically.

13. The base station of claim 11, wherein the signal includes an indication for configuring at least one of: a quality of service (QoS) limit, a data usage limit, a time usage limit, and an access control.

14. The base station of claim 11, wherein the signal includes a policy profile identity (ID).

15. The base station of claim 11, wherein the signal further includes a policy profile type information element (IE) defined by one or more of the following: a WTRU guaranteed bit rate (WTRU-GBR), a WTRU maximum bit rate (WTRU-MBR), a download limit, a day limit, and a traffic flow template (TFT).
